(19) United States
(12) Patent Application Publication
(10) Pub. No.: US 2009/0022609 A1
(43) Pub. Date: Jan. 22, 2009

(54) DEVICE FOR HYDROPROTECTION OF A BOREHOLE PUMP ELECTRIC MOTOR

(75) Inventors: Ivan Solomonovich Pyatov, Moscow (RU); Viktor Mihailovich Lysenko, Moscow (RU); Aleksey Vladimirovich Trulev, Moscow (RU)

Correspondence Address: WALKER & JOCKE, L.P.A., 231 SOUTH BROADWAY STREET, MEDINA, OH, 44256, US

(73) Assignee: Ivan Solomonovich PYATOV, Moscow (RU)

(21) Appl. No.: 12/162,800

(22) PCT Filed: Feb. 14, 2006
(86) PCT No.: PCT/RU06/00062

§ 371 Date: Jul. 31, 2008

(51) Int. Cl. F04D 13/10; H02K 5/12

(52) U.S. Cl. 417/423.3; 310/87; 417/423.11

(57) ABSTRACT

The invention relates to crude oil production, and can be suitably used for hydroprotection of submersible electric centrifugal motors. A hydroprotection protector of a borehole pump electric motor comprises at least one stage, which stage includes a cylindrical body (7), a tube (8) coaxially positioned inside said body and surrounding a shaft (5), nipples (9, 10), a damping bushing (11), an end-face seal (12) and an annular piston (13), which piston is adapted to reciprocate in an annular chamber (14), which chamber is defined within the space between the cylindrical body (7) and the tube (8). The piston (13) separates the chamber (14) into two areas (15, 16) filled, respectively, with the dielectric fluid and the formation fluid arriving from the annulus. Two protective annular elements (17, 18) are attached to the piston (13) end-face, contacting the formation fluid, the protective annular elements (17, 18) protrude beyond outline of the piston and are contiguous, respectively, to the body (7) interior surface and to the tube (8) exterior surface. The space between the elements (17, 18) and the surfaces of body (7) and tube (8), contiguous to said elements, is filled with a protective lubricant. Embodiment of the invention prevents the formation fluid from seeping into the chamber containing the dielectric fluid, and allows to avoid contamination and wear of chamber's surfaces subjected to friction.

### FIELD OF THE INVENTION

The invention relates to crude oil production, and can be suitably used for hydroprotection of the submersible electric centrifugal motors used to produce a fluid out of wells of different diameters and depths.

### PRIOR ART

Known is a device (protector) for hydroprotection of a submersible, lubricant oil-filled electric motor, disclosed in Utility Patent RU 47587 U1, publ. 27 08 2005, IPC H02K 5/12. Said device comprises a body, end-face seals, at least one chamber having a flexible diaphragm disposed therein, which diaphragm is secured by a neck on supports; a pressure-release valve, lubricant oil-supply and lubricant oil-discharge ports in the supports. Said device is further provided with protective flexible damping elements in the form of an hollow cylinder, which cylinder is positioned within the diaphragm at both end-faces of the diaphragm in the coaxial manner to define a cylinder's free area formed in the working area of the diaphragm, with a gap off the diaphragm interior surface; and in the form of the cylinder's supporting area disposed contiguously to the diaphragm interior surface neck in the zone of the diaphragm's fastening support; generatices of the supporting and free areas of each protective element are mated in the diaphragm neck curvature zone to define a narrower portion of the support area outer diameter; the outside end-face of the protective element supporting area being provided with a shoulder stop adjacent to the diaphragm neck outer end-face; the diaphragm is secured to the protective element on the fastening supports in the rigid manner using the strapping resilient rings having the end-face beads, and the flexible diaphragm, protective element and strapping rings are made of an elastic, oil- and chemically resistant material.

An essential drawback of this device is a possibility of rupture of the flexible diaphragm in the course of operation thereof, and, consequently, failure of that hydroprotection device. If said diaphragm is made more rigid for the purpose to prevent such rupture, then effectiveness of operation of the device decreases sharply.

The hydroprotection protector of a borehole pump electric motor, and its moveable mechanical module that separates a dielectric fluid and formation fluid arriving from the annuls, according to disclosure of U.S. Pat. No. 6,307,290 B1, publ. 23 10 2001, IPC H02K 5/132, F04D 13/08, may be adopted as the prototype of the first and third objects of the claimed group of teachings. Said hydroprotection protector of a borehole pump electric motor comprises: a shaft, radial and thrust bearings, and at least one stage consisting of a cylindrical body, a tube coaxially positioned within said cylinder and surrounding the shaft, first and second nipples, at least one damping bushing, an end-face seal, and an annular piston adapted to reciprocate in an annular chamber formed in the space between the cylindrical body and the tube so that to separate said annular chamber into two areas filled, respectively, with the dielectric fluid and the formation fluid arriving from the annulus. Accordingly, the moveable mechanical module comprised by the protector, that separates the dielectric fluid and the formation fluid arriving from the annulus, is an annular piston.

In said known device, such its “working member” as a flexible diaphragm for equalization of pressures of the dielectric fluid and the formation fluid arriving from the annulus, is not present. As the “working” member, in said hydroprotection protector for a borehole pump electric motor used is an annular piston disposed in the annular chamber between the body and the tube, which annular piston is adapted to reciprocate within said annular chamber. Thus, in this design of a hydroprotection device, disrupture of its “working” member is prevented.

However, in operation of such device, salts are deposited (products of reaction of the annular chamber walls and a chemically active formation fluid) on the cylindrical body inner wall and on the outer wall of the tube. And, consequently, such deposits can substantially prevent movement of the annular piston within the respective area of the annular chamber, to the extent of complete seizure and, accordingly, resulting in failure of the protector. Apart from that, said processes result in a worse wear of the body interior surface and the tube exterior surface due to the friction occurring between said surfaces and the annular cylinder, and, consequently, in a shorter durability of the protector.

As the prototype of the second object of the group of proposed teachings, the following device can be adopted: a hydroprotection compensator for a borehole pump electric motor, as disclosed in the book “Submersible centrifugal pumps for crude oil production”, scientific editors: V. Yu. Alekperov and V. Ya. Kirschenbaum, M., “Centr “Na'ouka i Technica”, 1999, p. 370, FIG. 416. Said compensator comprises: a cylindrical body, and a base secured on said body, which base has a passageway for fluid communication of the cylindrical body's inner cavity and the annulus; a head, and an elongated annular diaphragm, which diaphragm is mated, without any gap, with the base and head.

In this hydroprotection compensator of a borehole pump electric motor, a drawback, similar to the protective device of RU 47587 U1, is a possibility of rupture of the flexible diaphragm in the course of operation of the device, and subsequent failure of the compensator itself. If said diaphragm is made more rigid for the purpose to prevent such rupture, then effectiveness of operation of the compensator decreases sharply.

As regards the fourth object of the claimed group of teachings, being a constructional assembly comprised by a hydroprotection compensator of a borehole pump electric motor, this object, as such, has not any analogues in prior art, because a moveable mechanical module that separates the dielectric fluid and the formation fluid arriving from the annulus in a hydroprotection compensator of a borehole pump electric motor has been embodied essentially for the first time in the art. Said device can be practically embodied similarly to embodiment of the prior-art moveable mechanical module that separates the dielectric fluid and formation fluid arriving from the annulus in a protector of hydroprotection for a borehole pump electric motor. Both these devices in a compensator and protector, respectively, perform essentially the similar functions.

### DISCLOSURE OF THE INVENTION

The claimed invention is directed to prevent seepage of the formation fluid into the chamber containing the dielectric fluid, and also to prevent contamination and wear of the chamber surfaces subjected to friction.

Said goal is attained by a hydroprotection protector of a borehole pump electric motor, which protector comprises: a shaft connecting the pump and the electric motor, thrust and radial bearings for mounting the shaft, and at least one stage including a cylindrical body, a tube coaxially positioned inside said body and surrounding said shaft, first and second nipples, at least one damping bushing, an end-face seal, and an annular piston which is adapted to reciprocate in an annular chamber defined in the space between the cylindrical body and the tube and separates said annular chamber into two areas filled, respectively, with the dielectric fluid and the formation fluid arriving from the annulus, characterized in that the protector comprises two protective annular elements which are attached to the annular piston end-face, contacting the formation fluid, protrude beyond outline of the annular piston and are contiguous, respectively, to the cylindrical body interior surface and to the tube exterior surface, wherein the space between the protective annular elements and, respectively, the cylindrical body interior surface and the tube exterior surface is filled with a protective lubricant.

According to the preferable embodiment the protector comprises at least one additional annular piston positioned in the annular chamber, at the side of the annular piston end-face contacting the dielectric fluid, the additional annular piston is adapted to reciprocate in the annular chamber, wherein the space between the annular piston and the additional annular piston being filled with a separating medium. As the separating medium used is either a dielectric fluid having permittivity of 4-90 kW/cm, or a gas selected from the group consisting of air, an inert gas, hydrocarbon gas, a mixture of a dielectric fluid with a gas, or a protective lubricant.

Further, the annular piston and/or an additional annular piston may be provided with at least one seal at the place where the piston contacts the cylindrical body interior surface, and at least with one seal at the place where the piston contacts the tube exterior surface. In some cases, the annular piston and/or the additional annular piston may be provided with a support centering ring. The space between the annular piston exterior surface and the cylindrical body interior surface, as well as the space between the additional annular piston exterior surface and the cylindrical body interior surface are filled with a protective lubricant.

To exclude any possibility of seizure of the annular piston and/or the additional annular piston in the annular chamber, they can be implemented with the barrel-shaped exterior surface.

The protective annular elements can be implemented in a plurality of versions: in the form of the deformable or corrugated tubes, or in the form of rigid tubes.

In the version of the corrugated protective annular elements, inside the protective annular element contiguous to the cylindrical body interior surface, and outside the protective annular element contiguous to the tube interior surface the spring-loaded elements, contacting mechanically said protective element, and urging the protective annular elements, respectively, towards the cylindrical body inner surface and towards the tube exterior surface, may be installed.

In the version where the protective annular elements are implemented in the form of rigid tubes, in the protective annular elements, on the surfaces contiguous, respectively, to the cylindrical body interior surface and the tube exterior surface—implemented are recesses to accommodate a lubricant; and outside the protective annular element contiguous to the cylindrical body interior surface, and inside the protective annular element contiguous to the tube exterior surface—fitted are seales.

In each one of the stages, the second nipple may have a passageway that connects the annular chamber's area filled with the formation fluid to the annulus, said passageway may be provided with a filter therein.

Furthermore, the annular piston may be provided with at least one port to charge a separating medium therethrough; which port may have a locking device.

A pumping arrangement may be positioned on the shaft between the annular chamber filled with the dielectric fluid, and the end-face seal.

The above mentioned goal is accomplished by a compensator of hydroprotection of a borehole pump electric motor, comprising a cylindrical body and a base secured on said cylindrical body, and which base has a passageway for fluid communication of the cylindrical body inner cavity to the annulus, a piston positioned inside the cylindrical body and adapted to reciprocate and separate the space in the cylindrical body into two cavities filled with a dielectric fluid and formation fluid arriving from the annulus, respectively, and a protective annular element attached to the piston end-face contacting the formation fluid, the protective annular element protrudes beyond the piston outline and is contiguous to the cylindrical body interior surface, wherein the space between the protective annular element and the cylindrical body interior surface is filled with a protective lubricant.

In a preferred embodiment of the claimed compensator, inside the cylindrical body, at the piston side contacting the dielectric fluid, positioned is at least one additional piston, the space between the piston and the additional piston is filled with a separating medium. As such separating medium, a dielectric fluid having permittivity of 4-90 kW/cm, or a gas selected from the group consisting of air, an inert gas, a hydrocarbon gas, a mixture of a dielectric fluid with a gas, or a protective lubricant, can be used.

Further, the piston and/or the additional piston may be provided with at least one seal at the place where the piston contacts the cylindrical body interior surface. In some cases, the piston and/or additional piston may be provided with a support centering ring. The space between the piston exterior surface and the cylindrical body interior surface, as well as the space between the additional piston exterior surface and the cylindrical body interior surface are filled with a protective lubricant.

To exclude any possibility of seizure of the piston and/or additional piston in the cylindrical body, said pistons can be implemented with the barrel-shaped exterior surface.

The protective annular element can be implemented in a plurality of versions: in the form of the deformable or corrugated tubes, or in the form of a rigid tube.

In the version of the corrugated protective annular element, inside the protective annular element contiguous to the cylindrical body interior surface—the spring-loaded elements, contacting mechanically said protective element, and urging the protective annular elements, respectively, towards the cylindrical body inner surface may be installed.

In the version where the protective annular element is implemented in the form of a rigid tube, in the protective annular element, on the surface contiguous, respectively, to the cylindrical body interior surface—implemented are recesses to accommodate a lubricant, and outside the protective annular element contiguous to the cylindrical body interior surface—fitted are seales.

In the base passageway, via which the cylindrical body inner cavity communicates with the annulus, a filter may be provided therein to clear the formation fluid from mechanical particles.

The piston may be further provided with at least one port for charging a separating medium therethrough, which port may be equipped with a locking device.

The above goal is also achieved by a moveable mechanical module separating the dielectric fluid and the formation fluid arriving from the annulus, comprised by of hydroprotection protector of a borehole pump electric motor, which protector has an annular piston and two protective annular elements attached to one of end-faces of the annular piston and protrude beyond the piston outline, wherein first of which elements has the inner diameter approximately equal to the inner diameter of the annular piston, and the second element of said elements has the outer diameter that is approximately equal to the outer diameter of the annular piston.

The protective annular elements can be implemented in a plurality of versions: in the form of the deformable or corrugated tubes, or in the form of rigid tubes.

In the version of the corrugated protective annular elements, inside the protective annular element of the greater diameter, and outside the protective annular element of the smaller diameter—the spring-loaded elements, contacting mechanically said element, may be installed.

In the version where the protective annular elements are implemented in the form of rigid tubes, outside the protective annular element of the greater diameter, and inside the protective annular element of the smaller diameter—implemented are recesses to accommodate a lubricant.

To avoid any possibility of seizure of the annular piston in the annular chamber, the piston may be made with the barrel-shape of the exterior surface.

The annular element is advantageously made of a corrosion-resistant metal, or a chemically resistant material (i.e. a material that withstands the action of chemically active media) and a heat-resistant polymer material.

The above goal is also achieved by a moveable mechanical module, that separates the dielectric fluid and the formation fluid arriving from the annulus in a compensator for hydroprotection of a borehole pump electric motor, comprises a piston, and a protective annular element attached to one of end-faces of the piston, protruding beyond the piston outline and having the outer diameter that is approximately equal to the piston outside diameter.

The annular element may be implemented in versions: in the form of a deformable or corrugated tube, or as a rigid tube.

In its corrugated version of the protective annular element, at least one spring-loaded element, mechanically contacting said protective element, can be provided inside the protective annular element.

If the protective annular element is implemented as a rigid tube, said protective annular element may have recessions outside thereof, which recesses accommodate a lubricant.

The piston advantageously is made of a corrosion-resistant, or chemically resistant and heat-resistant polymer material.

### BRIEF DESCRIPTION OF DRAWINGS

The claimed group of inventions is explained by the following drawings:

FIG. 1 schematically shows an arrangement of assemblies of hydroprotection of a borehole pump electric motor, provided with a compensator.

FIG. 2 schematically shows an arrangement of assemblies of hydroprotection of a borehole pump electric motor, having no compensator.

FIG. 3 shows a longitudinal section of the protector of hydroprotection according to the invention.

FIG. 4 shows a longitudinal section of a protector of hydroprotection of a borehole pump electric motor, having an additional annular piston.

FIG. 5 shows an area of a protector of hydroprotection of a borehole pump electric motor, in which area the annular piston is provided with a support centering ring; the protective annular elements are corrugated and provided with spring-loaded elements that urge said protective annular elements towards the cylindrical body and towards the tube; the locking device being implemented as a plug.

FIG. 6 shows an area of a protector of hydroprotection of a borehole pump electric motor, wherein the annular piston is provided with a number of seals at the place where said piston contacts the cylindrical body interior surface, and at the place where the piston contacts the tube exterior surface; the protective annular elements are implemented in the form of a rigid tube, and are provided with recesses to accommodate a protective lubricant, and with a seal; the locking device being implemented in the form of a valve.

FIG. 7 shows a longitudinal section of a compensator of hydroprotection of a borehole pump electric motor, in its basic implementation.

FIG. 8 shows a longitudinal section of a compensator of hydroprotection of borehole pump electric motor, having an additional piston.

FIG. 9 shows an area of a compensator of hydroprotection of borehole pump electric motor, wherein a protective annular element is corrugated and is provided with spring-loaded elements that urge this protective annular element towards the cylindrical body.

FIG. 10 shows an area of a compensator of hydroprotection of borehole pump electric motor, wherein the piston is provided with a number of seals at the place where it contacts the cylindrical body interior surface, and the protective annular element is implemented in the form of a rigid tube, and is provided with recesses accommodating a protective lubricant, and with a seal.

FIG. 11 shows a moveable mechanical module of a protector of hydroprotection of a borehole pump electric motor, which protector has the corrugated protective annular elements.

FIG. 12 shows a moveable mechanical module of a protector of hydroprotection of a borehole pump electric motor, wherein the protective annular elements are implemented in the form of rigid tubes and are provided with recesses accommodating a protective lubricant.

FIG. 13 shows a moveable mechanical module of a compensator of hydroprotection of a borehole pump electric motor having the corrugated protective annular element.

FIG. 14 shows a moveable mechanical module of a compensator of hydroprotection of a borehole pump electric motor, wherein the protective annular element is implemented as a rigid tube and is provided with recesses accommodating a protective lubricant.

FIG. 15 shows a moveable mechanical module of a protector of hydroprotection of a borehole pump electric motor having a barrel-shaped exterior surface.

FIG. 16 shows a moveable mechanical module of a compensator of hydroprotection of a borehole pump electric motor having a barrel-shaped exterior surface.

The currently used devices of hydroprotection of a borehole pump electric motor may be embodied in two versions.

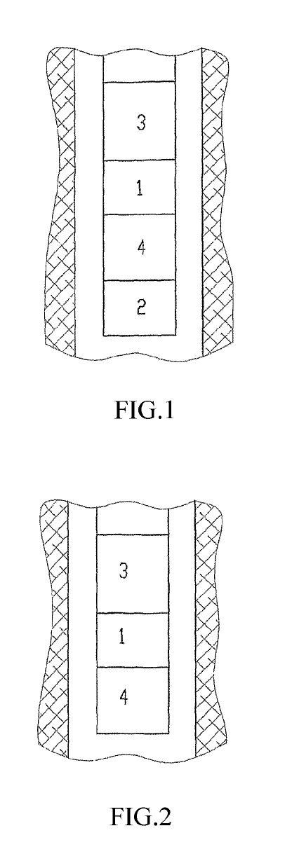

In the first variant, as a device for hydroprotection used are protector 1 and compensator 2, protector 1 being disposed between borehole pump 3 and its electric motor 4, and compensator 2 is disposed immediately over electric motor 4. A diagram relating to this Version is shown in FIG. 1.

In the second variant, as a device for hydroprotection used is only one protector 1 (without a compensator); protector 1 being disposed between borehole pump 3 and its electric motor 4. In production of crude oil, it is this arrangement of the main elements of production equipment that has been recently preferred. The schematic arrangement of the hydroprotection elements relating to that Version is shown in FIG. 2.

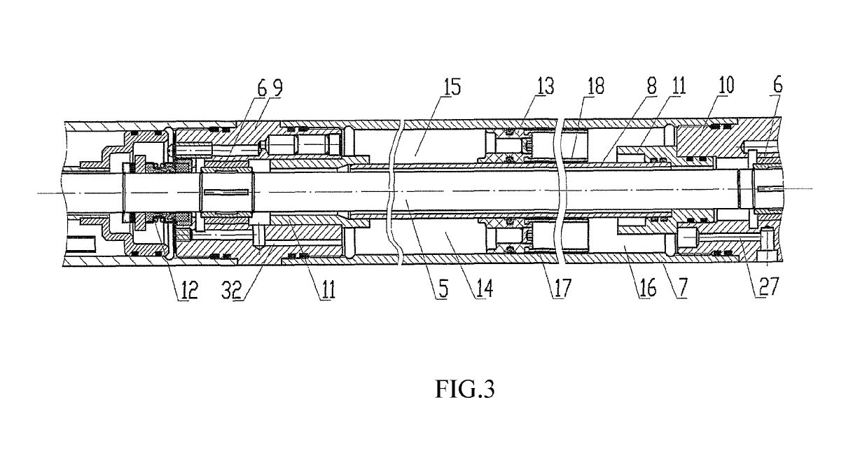

The protector of hydroprotection of a borehole pump electric motor, in its basic embodiment, is shown in FIGS. 3-6, and comprises: shaft 5 that transfers the torque from the electric motor shaft to that of a centrifugal borehole pump (not shown in FIG. 3); thrust and radial bearings 6, and at least one stage. In general, 1-3 stages are used, depending on a type of an electric motor, and on composition of a produced formation fluid. Each one of such stages includes cylindrical body 7, tube 8 that is coaxially positioned in said body and surrounds shaft 5; first and second nipples 9, 10, at least one damping bushing 11, end-face seal 12 and annular piston 13. Said annular piston 13 is positioned in annular chamber 14, that is defined in the space between cylindrical body 7 and tube 8, thereby separating this annular chamber into two portions 15 and 16, respectively filled with the dielectric fluid (15) and the formation fluid (16) arriving from the annulus. Annular piston 13 is moveable, i.e. it is adapted to reciprocate within said annular chamber 14.

As the main requirements to be met by the dielectric fluid filling electric motor 4, are its high electrical resistance and anti-friction properties, for that reason as such fluid used is MDPN lubricant or any other lubricant oil having permittivity not lower than 4 kW/cm. Said lubricant oil also reliably reduces wear of triboconnections in electric motor 4.

The main feature of the claimed technical solution is as follows: to end-face of annular piston 13, contacting the formation fluid, attached are two protective annular elements 17, 18 that protrude beyond the annular piston outline. The first element 17 is contiguous to the interior surface of cylindrical body 7, and the second element 18, is contiguous to the exterior surface of tube 8. The space between protective annular elements 17, 18 and the surface of the elements of the protector, to which they are contiguous (i.e. a respective surface of cylindrical body 7 and tube 8), are filled with a protective lubricant.

For the reason that in operation of the claimed modification of a hydroprotection protector, wherein as the “working member” responding to the pressure of the formation fluid arriving from the annulus used is annular piston 13 disposed in the corresponding annular chamber 14, the steady reciprocation of that piston within annular chamber 14 must be ensured. It is this purpose, for which used are said protective annular elements 17, 18, between which annular elements and the surfaces of the protector 1 elements, to which said annular elements are adjacent, the protective lubricant is provided. The protective annular elements 17, 18 that, with the protective lubricant therein, move jointly with annular piston 13, protect the cylindrical body 7 inner surface and the tube 8 exterior surface against deposition of salts and paraffins, prevent corrosion, and reduce friction between annular piston 13 and said surfaces of the protector 1 elements, and they actually exclude any possibility of seizure of annular piston 13 in annular chamber 14.

To improve reliability of separation of the dielectric fluid and the formation fluid in annular chamber 14: to said chamber, at the side of the annular piston 13 end-face contacting the dielectric fluid, fitted is at least one additional annular piston 19 adapted to reciprocate in annular chamber 14 in conjunction with annular piston 13. In this arrangement, the space between annular piston 13 and additional annular piston 19 is filled with separating medium 20. As said separating medium 20 used is either a dielectric fluid, e.g. MDPN lubricant oil, or any other lubricant oil having permittivity of 4-90 kW/cm, or a gas selected from the group consisting of: of air, an inert gas, hydrocarbon gas, or a mixture of a dielectric fluid with a gas, or a protective lubricant.

To reduce further the friction between the moveable annular piston 13 and additional annular piston 19 and the fixed constructional elements, in particular, cylindrical body 7, the space between the exterior surface of annular piston 13 and the cylindrical body 7 interior surface, as well as the space between the exterior surface of additional annular piston 19 and the cylindrical body 7 interior surface, are usually filled with a protective lubricant.

To avoid any leakage from one area of annular chamber 14 to any other area therein, annular piston 13 and/or additional annular piston 19 are provided with at least one seal 21 at the place where the piston contacts the cylindrical body 7 interior surface, and with at least one seal 21 where the piston contacts the tube 8 exterior surface. For the same purpose, annular piston 13 and/or additional annular piston 19 may be provided with centering ring 22.

Annular piston 13 and/or additional annular piston 19 may be implemented with their barrel-shaped exterior surface 23, so that to reduce probability of its (piston's) seizure in annular chamber 14.

Protective annular elements 17, 18 may be implemented in their versions: in the form of deformable tubes or corrugated tubes, or in the form of rigid tubes.

The protective annular elements 17, 18, implemented as the deformable tubes (FIG. 3), are made of an elastomer or fabric, or polymer film, and they are adapted—as an annular piston moves—to fold and unfold in the longitudinal direction, with subsequent change of length of the protective annular elements.

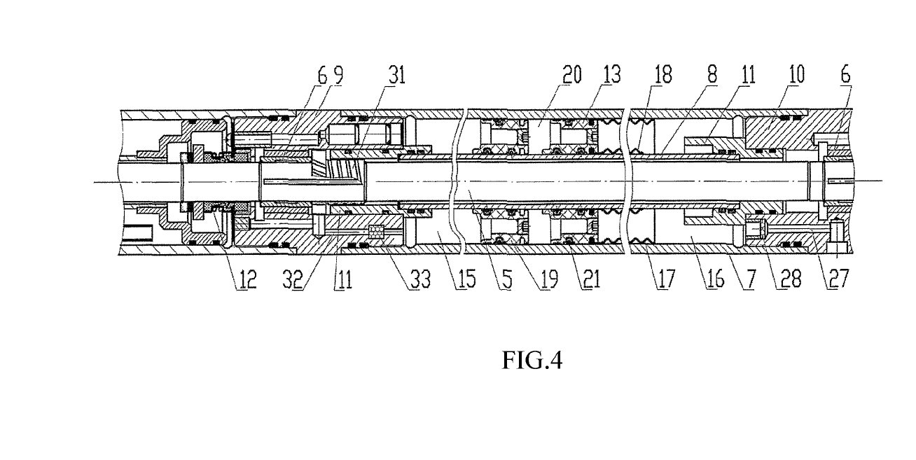

In the version of the corrugated protective annular elements 17, 18 (FIG. 4, 5): the corrugation may be either the annular one, or arranged along the helical line; and in this case the protective annular elements are made of either an elastomer, or fabric, or a polymer fabric, and, similar to the first Version, the protective annular element may change its length as an annular piston moves. In this Version, to ensure a more tight compression of the protective annular elements 17, 18, respectively, against the cylindrical body 7 interior surface and against the tube 8 exterior surface within protective annular element 17 contiguous to the cylindrical body 7 interior surface, and outside the protective annular element 18 contiguous to the tube 8 exterior surface: positioned are spring-loaded elements 24 that contact said protective element and urge said protective annular elements 17, 18 towards the cylindrical body 7 interior surface and towards the tube 8 exterior surface, respectively. Said spring-loaded elements 24 may be implemented as an extension spring to urge protective annular element 17 towards the cylindrical body 7 interior surface, and as a compression spring to urge annular element 18 towards the tube 8 exterior surface.

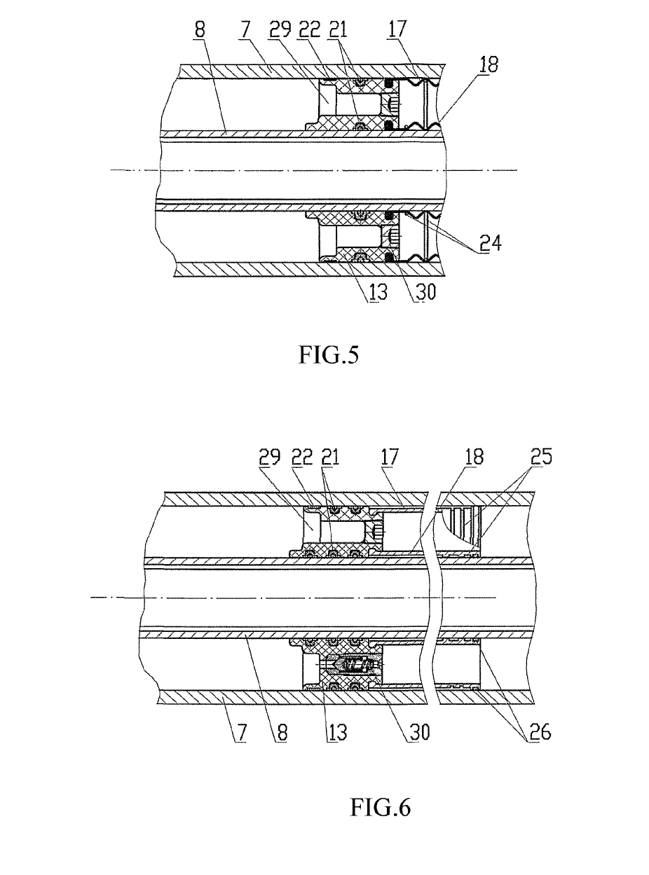

In the version where protective annular elements 17, 18 are implemented in the form of rigid tubes (FIG. 6), said tubes are made of a metal or plastic in the form of cylindrical or corrugated tubes. To ensure a sufficient supply of a protective lubricant on the friction surfaces in the protective annular elements on the surfaces contiguous, respectively, to the cylindrical body interior surface and to the tube exterior surface: provided are recesses 25 that accommodate a protective lubricant. The recesses may be implemented either in the form of annular grooves, or helical grooves, or in the form of pits. To prevent the protective lubricant from being washed-out: outside the protective annular element contiguous to the cylindrical body interior surface, and inside the protective annular element contiguous to tube exterior surface - provided are seals 26.

To prevent the formation fluid from ingressing into the respective area of annular chamber 14: the second nipple 10 may be provided with passageway 27 that will connect area 16 of annular chamber 14, filled with the formation fluid, to the annulus; said passageway being equipped with filter 28.

For charging the space between annular piston 13 and additional annular piston 19 by separating medium 20: annular piston 13 may have at least one port 20 with locking device 30 positioned therein. This device may be implemented either in the form of a plug (FIG. 5), or a valve (FIG. 6).

To maintain durability of an end-face seal, said seal should operate in the clear dielectric fluid, not in the formation fluid that may contain mechanical inclusions. For that purpose, pressure of the dielectric fluid upstream of a seal must exceed that of the formation fluid.

Pumping device 31 positioned on shaft 5 of protector 1 between area 15 of annular chamber 14, which area is filled with the dielectric fluid, and end-face seal 12 allow the pressure difference required for durable operation of the end-face seal.

Pumping device 31 pumps the dielectric fluid through passageway 32 and filter 33, and in this manner the dielectric fluid is cleared.

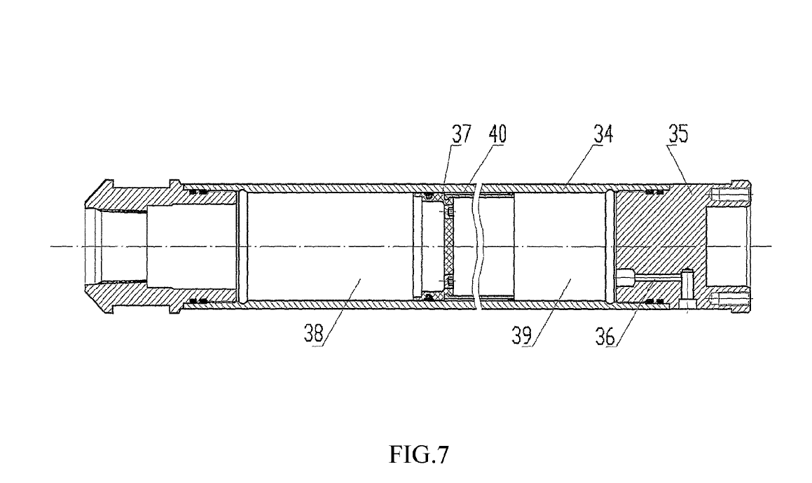

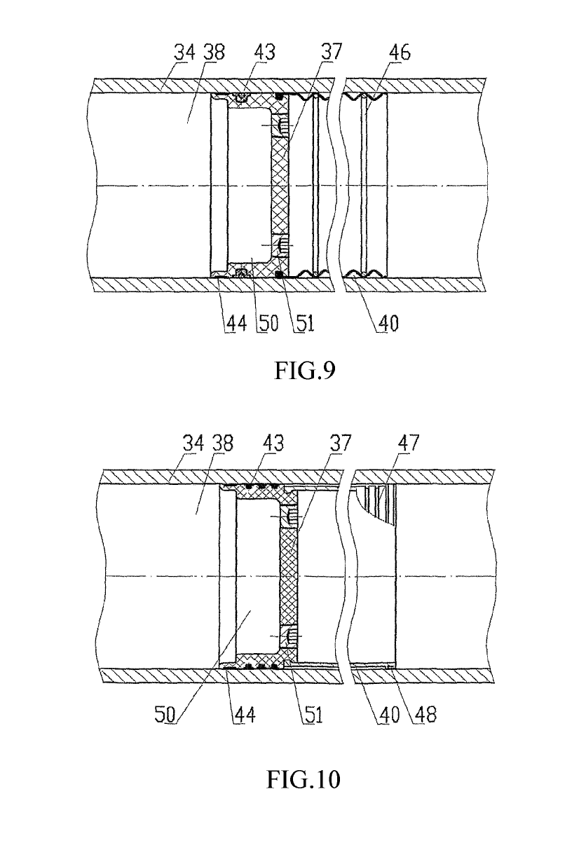

The compensator of hydroprotection of a borehole pump electric motor, shown in FIGS. 7-10, essentially comprises cylindrical body 34 and base 35 secured on said body, in which base passageway 36 for fluid communication of the cylindrical body 34 inner cavity with the annulus is provided.

As distinct over the art most pertinent to the claimed invention, within cylindrical body 34 positioned is piston 37 that separates the space inside cylindrical body 34 into two cavities 38, 39, which cavities are filled with the dielectric fluid and the formation fluid arriving from the annulus, respectively. Said piston 37 is adapted to reciprocate inside cylindrical body 34.

The main distinguishing feature of the claimed invention consists in that to piston 37 end-face, contacting the formation fluid, attached is protective annular element 40 that protrudes beyond outline of piston 37 and is adjacent to the cylindrical body 34 interior surface. The space between protective annular element 40 and the cylindrical body 34 interior surface must be filled with a protective lubricant.

Similarly to the hydroprotection protector, in the claimed modification of a compensator: piston 37 in cylindrical body 34 serves as the “working member” that responds to pressure of the formation fluid arriving from the annulus. To ensure steady reciprocation of piston 37 in cylindrical body 34, used is the above-mentioned protective annular element 40, between which annular element and the cylindrical body 34 interior surface a lubricant has been applied. Moving together with piston 37, protective annular element 40 with the protective lubricant accommodating therein protects the cylindrical body 34 interior surface against deposition of salts and paraffins, prevents corrosion and reduces friction between piston 37 and the cylindrical body 34 interior surface, and essentially excludes possibility of seizure of piston 37 in cylindrical body 34.

To enhance reliability of separation of the dielectric fluid and the formation fluid in cylindrical body 34: to said body, at the side of the piston 37 end-face contacting the dielectric fluid, positioned is at least one additional piston 41 adapted to reciprocate in cylindrical body 34 conjunctly with piston 37. Here, the space between piston 37 and additional piston 41 is filled with separating medium 42. As said separating medium 42 used is either a dielectric fluid having permittivity of 4-90 kW/cm (e.g. MDPN lubricant oil), or a gas selected from the group of air, an inert gas, hydrocarbon gas, or a mixture of a dielectric fluid with a gas, or a protective lubricant.

For further reducing of friction between the moveable piston 37 and additional piston 41 of the protector and cylindrical body 34, the space between the piston 37 exterior surface and the cylindrical body 34 interior surface usually is filled with a protective lubricant.

To avoid any leakage from one cavity of cylindrical body 34 to any other cavity therein, piston 37 and/or additional annular piston 41 are provided with at least one seal 43 at the place where the piston contacts the cylindrical body 34 interior surface. For the same purpose, piston 37 and/or additional annular piston 41 may be provided with centering ring 44.

Piston 37 and/or additional annular piston 41 may be implemented with their barrel-shaped 45 exterior surface, so that to reduce probability of its (piston's) seizure in cylindrical body 34.

Protective annular element 40 may be implemented in its versions: in the form of a deformable tube or corrugated tube, or in the form of a rigid tube.

Protective annular element 40 implemented in the form of a deformable tube (FIG. 7) is made of an elastomer or fabric, or a polymer film, and, as the annular piston moves, said annular element is capable of folding and unfolding in the longitudinal direction, a length of the protective annular element being changed thereby.

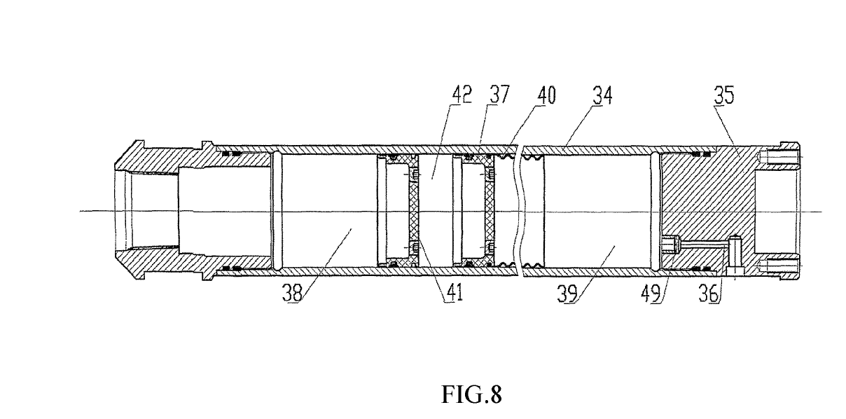

In the version of the corrugated protective annular element 40 (FIG. 8, 9), the corrugation may be either the annular one, or implemented along the helical one; the annular element being made of either an elastomer, or fabric, or a polymer fabric, and, similar to the first Version, the protective annular element may change its length as an annular piston moves.

To ensure a more tight compression of the protective annular element 40, respectively, against the cylindrical body 34 interior surface, inside protective annular element 40, contiguous to the cylindrical body 34 interior surface, positioned are spring-loaded elements 46 that contact said protective element and urge said element 40 towards the cylindrical body 34 interior surface, respectively. Said spring-loaded elements 46 may be implemented as an extension spring to urge protective annular element 40 towards the cylindrical body 34 interior surface.

In the version where protective annular element 40 is implemented in the form of a rigid tube (FIG. 12), said element is made of a metal or plastic in the form of cylindrical or corrugated tubes. To ensure a sufficient supply of a protective lubricant on the friction surfaces in protective annular element 40: on the surface contiguous, respectively, to the cylindrical body 34 provided are recesses 47 that accommodate a protective lubricant. The recesses may be implemented either in the form of annular grooves, or helical grooves, or in the form of pits. To prevent the protective lubricant from being washed-out: outside protective annular element 40 contiguous to the cylindrical body 34 interior surface - provided are seals 48.

To clear the formation fluid, that is pumped into cavity 39 of cylindrical body 34, from any gross mechanical inclusions: passageway 36, disposed in base 35 and connecting the cylindrical body 34 inner cavity to the annulus, may be provided with filter 49 positioned therein.

For charging the space between piston 37 and additional piston 41 by separating medium 42: piston 37 may have at least one port 50 for charging separating medium 42, which port has locking device 51 positioned therein. This locking device may be implemented either in the form of a plug (FIG. 10), or a valve.

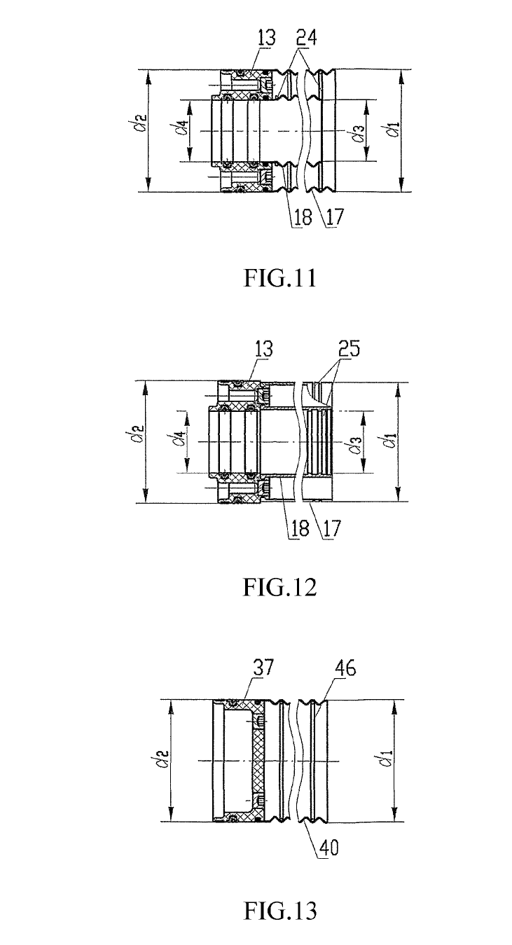

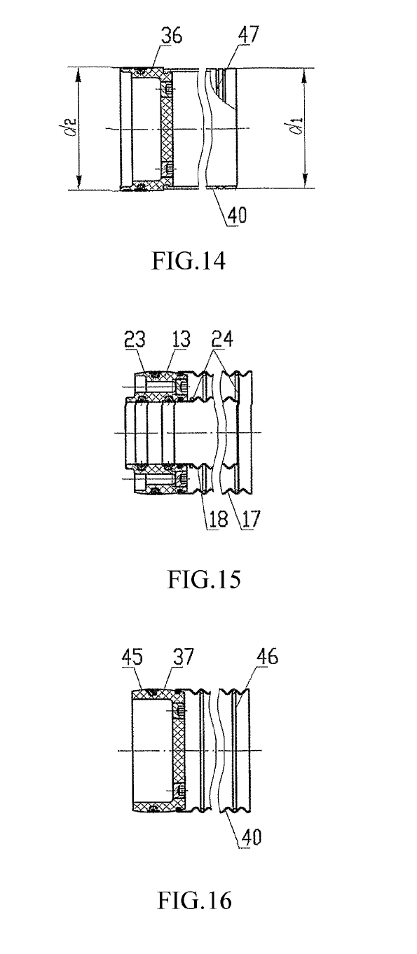

The moveable mechanical modules, that separate the dielectric fluid and the formation fluid arriving from the annulus in protector 1 and compensator 2, are discussed in the paragraphs that describe the protector and compensator, respectively, of hydroprotection of a borehole pump electric motor, and said modules are shown in FIGS. 11, 12, 15 and 13, 14, 16, respectively.

As it was mentioned above, the moveable mechanical module includes annular piston 13 and two protective annular elements 17, 18 attached to one of end-faces of said annular piston 13 and protruding beyond outline of said piston. First element, 18, has the inner diameter approximately equal to the inner diameter of annular piston 13; and the second element, 17, has the outer diameter approximately equal to the outer diameter of annular piston 13 (FIG. 11).

A moveable mechanical module includes piston 37 and protective annular element 40 attached the one of end-faces of said piston 37, and protruding beyond outline of said piston and having the outer diameter approximately equal to the piston 37 outer diameter (FIG. 13).

Regarding the first moveable mechanical module of said moveable mechanical modules, the inner diameter of one of the protective annular elements 18 is indicated to be approximately equal to the annular piston 13 inner diameter, and the outer diameter of the second element 17, protective annular elements is indicated to be approximately equal to the annular piston 13 outer diameter. Similarly, in respect of the second moveable mechanical module of said moveable mechanical modules, it is mentioned that protective annular element 40 has the outer diameter approximately equal to the piston 37 outside diameter. As regards said feature of “approximately”, it must be noted that the second protective annular element 17 and protective annular element 40 ideally should have the outer diameter exactly equal to the annular piston 13 outer diameter and the piston 37 outer diameter; and the first of said protective annular elements, 18, should ideally have the inner diameter exactly equal to the annular piston 13 inner diameter. But for the reason that technically it is just impossible to realize the exact coincidence of said diameters, in this disclosure said dimensions interrelate as approximately equal, and said “approximate” equality is characterized by a certain machining allowance of ratio of respective diameters, selected in view of the design considerations (on the one hand, protective annular elements 17 and 40 must be tightly urged towards their respective surface of protector 1 or compensator 2, lubricated by them; and, on the other hand, said elements must not be seized when a piston, to which they are attached, moves).

In this disclosure, the “approximately equal” term means that outer diameter of protective annular elements 17 and 40 are determined by the following ratio: d₁=(0.9-1.1)d₂, where d₁ is the protective annular element 17 and 40 outer diameter; d₂ is the outer diameter of annular piston 13 and piston 37; and the protective annular element 18 inner diameter is determined by the following ratio: d₃=(0.9-1.1)d₄, where d₃ is the inner diameter of protective annular element 18, and d₄ is the inner diameter of annular piston 13.

Both annular piston 13 comprised by the moveable mechanical module of hydroprotection protector 1, and piston 37 comprised by the moveable mechanical module of compensator 2 are made of a corrosion-resistant metal, or a chemically-resistant and heat-resistant polymer material. These materials provide a longer service life for the claimed moveable mechanical modules.

The moveable mechanical modules of the claimed protector and compensator can be suitably used in other designs, e.g. in measuring instruments.

The Basic Embodiment of the Invention

The claimed protector of hydroprotection of a borehole pump electric motor operates as follows.

Shaft 5 of protector 1, which shaft is supported on radial bearings 6, transfers torque from electric motor shaft 4 to that of borehole pump 3. It should be noted that when the crude production equipment is still being lowered down the well, area 16 of annular chamber 14 of the hydroprotection protector is filled with the formation fluid via passageway 27 having filter 28, which passageway is arranged in second nipple 10. Area 15 of annular chamber 14 is preliminarily filled with the dielectric fluid through an annular passageway disposed between shaft 5 and tube 8, via passageway 32 in first nipple 9. Tube 8 is supported on damping bushings 11. Annular piston 13, positioned in annular chamber 14 and having a seal 21 and centering ring 22, prevents ingress of the formation fluid to area 15 of annular chamber 14, which area communicates with an inner sealed cavity of electric motor 4. As this occurs, the formation fluid is also separated from the dielectric fluid by means of end-face seal 12.

When electric motor 4 is activated (or when its rpms increase), the dielectric fluid within its inner cavity is heated and gradually expands (its working volume increases), and, consequently, pressure of the dielectric fluid in the electric motor 4 inner cavity and in the hydroprotection protector 1 cavity being in fluid communication with said first cavity, i.e. pressure of area 15 of annular chamber 14, grows. To prevent said pressure from prying end-face seal 12, said changes of pressure in the dielectric fluid filling electric motor 4 must be damped somehow. For that purpose, annular piston 13 is adapted to reciprocate in annular chamber 14. Said annular piston 13, each time when the dielectric fluid pressure has grown, as discussed above, shifts in annular chamber 14 towards area 16 that contains the formation fluid. As pressure decreases, said piston shifts towards the area containing the dielectric fluid (resets).

As the formation fluid includes a large amount of chemically active substances, in the course of operation of a crude-producing well on walls of the annular chamber (i.e. on the inner wall of cylindrical body 7 and on the tube 8 outside wall) deposited are various salts being the product of the reaction of the chemically active formation fluid and the annular chamber 14 walls. Said deposition of salts is an essential obstacle to movement of annular piston 13 in annular chamber 14. Apart from the circumstance that such deposition causes an increased wear of walls of cylindrical body 7 and tube 8, there is probability that annular piston 13 may “get stuck” on said walls. To avoid such problem, to annular piston 13 at the formation fluid side, attached are protective annular elements 17, 18, between which elements and surface of the protector elements, to which said annular elements are adjacent, a protective lubricant is applied. Protective annular elements 17, 18, being moved jointly with annular piston 13, protect walls of annular chamber 14 and 18 against deposition of salts, and provide smooth movement of annular piston 13 in annular chamber 14.

The annular piston 13, together with annular elements 17, 18 secured thereon constitute a moveable mechanical module that separates the dielectric fluid and the formation fluid arriving from the annulus in protector 1 of hydroprotection of a borehole pump electric motor.

In the embodiment using additional annular piston 19, the mode of operation of the protector does not change essentially. In this case, the dielectric fluid in area 15 of annular chamber 14 will exert pressure on additional annular piston 19, and said piston in its turn—via separating medium 20, preliminarily charged through port 29 closed by locking device 30—will transmit said pressure on annular piston 13. Owing to this arrangement, probability of failed tightness i.e. ingress of the formation fluid into the shaft 5 cavity of annular chamber 14 will be considerably reduced.

In the embodiment of the annular elements, according to which said elements are corrugated and have spring-loaded elements 24 that urge annular elements 17, 18, respectively, towards the cylindrical body 7 interior surface and towards the tube 8 exterior surface; as well as in the embodiment of the annular elements in the form of rigid tubes with the use of seals 26, being positioned outside protective annular element 17 and inside protective annular element 18, and being contiguous, respectively, to the cylindrical body 7 interior surface and to the tube 8 exterior surface,—the operation principle of the claimed protector 1 unit also does not change. In the former case, a better fit of annular elements 17, 18 to the cylindrical body 7 interior surface and to the tube 8 exterior surface is achieved, and in the latter case any washing-out of the protective lubricant is prevented.

Pumping device 31, that is positioned on the protector shaft 5 between area 15 of annular chamber 14, which area is filled with the dielectric fluid, and end-face seal 12, provides the pressure difference between the dielectric fluid and formation fluid that is required for reliable and durable operation of the end-face seal. In this case, the end-face is cooled and lubricated by the clear dielectric fluid, and not by the formation fluid that has solid mechanical inclusions.

Pumping device 31 pumps the dielectric fluid through passageway 32 and filter 33, and in this way the dielectric fluid is cleared.

Each one of the embodiments disclosed in dependent claims of this invention has its own functionality (see “Brief Description of Drawings” Section), but as these embodiments do not make any essential contribution to the operation principle (mode) of the protector, they are not discussed in this Disclosure section.

Compensator 2 of hydroprotection of a borehole pump electric motor operates as follows.

As the crude-producing equipment is lowered into a well, cavity 39 of cylindrical body 34 of the hydroprotection compensator is filled with the formation fluid via passageway 36 having filter 49, which passageway is arranged in base 35. At the same time, cavity 38 of cylindrical body 34, being in fluid communication with the electric motor inner cavity, has been preliminarily filled with the dielectric fluid. Piston 37, positioned in the cylindrical body 34 and having seal 43 and centering ring 44, prevents any ingress of the formation fluid into cavity 38 of cylindrical body 34, which cavity is in fluid communication with the inner sealed cavity of electric motor 4.

As indicated above, when electric motor 4 is activated or its rpms increase, the dielectric fluid contained in its inner cavity is heated and starts to expand gradually (its working volume grows), and, consequently, the dielectric fluid pressure in the electric motor 4 inner cavity and in the hydroprotection compensator 2 cavity 38, being in fluid communication with the former cavity, increases. If the means of hydroprotection protector 1 do not suffice to damp a change in the pressure of the dielectric fluid that has filled electric motor 4, then this function will be performed additionally also by hydroprotection compensator 2. For that purpose, piston 37 is adapted to reciprocate in cylindrical body 34. Said annular piston 37, each time when the dielectric fluid pressure has grown, as discussed above, shifts in cylindrical body 34 towards cavity 39 that contains the formation fluid. As the pressure decreases, said piston shifts towards cavity 38 containing the dielectric fluid (resets).

As the formation fluid includes a large amount of chemically active substances, in the course of operation of a crude-producing well on walls of the cylindrical body 34 deposited are various salts being the product of the reaction of the chemically active formation fluid and the cylindrical body 34 walls. Said deposition of salts is an essential obstacle to movement of piston 37 in cylindrical body 34. Apart from the circumstance that such deposition causes an increased wear of the inner wall of cylindrical body 34, there is probability that annular piston 34 may “get stuck” on said walls. To avoid such problem, to piston 37, at the formation fluid side, attached is protective annular element 40, between which element and the interior surface of cylindrical body 4 a protective lubricant is applied. Protective annular element 40 being moved jointly with piston 37, protects walls of cylindrical body 34 against deposition of salts, and provides smooth movement of piston 37 in cylindrical body 34.

Said piston 37, together with protective annular element 40 secured thereon, constitute the moveable mechanical module that separates the dielectric fluid and the formation fluid arriving from the annulus in compensator 2 of hydroprotection of a borehole pump electric motor.

In the embodiment using an additional piston 41, the mode of operation of the compensator does not change essentially. In this case, the dielectric fluid in cavity 38 of cylindrical body 34 will exert pressure on additional piston 41, and said additional piston in its turn—via separating medium 42 preliminarily charged through port 50 closed by locking device 51—will transmit said pressure on piston 37. Owing to this arrangement, probability of tightness failure i.e. ingress of the formation fluid into the electric motor 4 cavity in cylindrical body 34 will be considerably reduced.

In the embodiment of the annular element, according to which embodiment said element is corrugated and has spring-loaded elements 46 that urge annular element 40, respectively, towards the cylindrical body 34 interior surface; as well as in the embodiment of the annular element 40 in the form of a rigid tube with the use of seal 40 and positioned outside protective annular element 40 contiguous to the cylindrical body 34—the operation principle of the claimed compensator 2 assembly also does not change. In the former case, a better fit of protective annular element 40 to the cylindrical body 34 interior surface is achieved, and in the latter case washing-out of the protective lubricant is prevented.

Each one of the embodiments of the claimed compensator 2 disclosed in dependent claims of this invention has its own functionality (see “Brief Description of Drawings” Section), but as these embodiments do not make any essential contribution to the operation principle (mode) of the compensator, they are not discussed in this disclosure.

The claimed design of a protector and compensator of hydroprotection of a borehole pump electric motor, wherein, as the working element (a moveable mechanical element) used is a piston provided with protective annular element(s), virtually eliminates a possibility of failure of said protector and compensator; and further, as compared with the prior-art pistoned hydroprotection protector, in the claimed protector and compensator the working surfaces of the tribomating elements actually are not subjected to wear.

1. A hydroprotection protector of a borehole pump electric motor, which protector comprises: a shaft connecting the pump and the electric motor, thrust and radial bearings for mounting the shaft, and at least one stage including a cylindrical body, a tube coaxially positioned inside said body and surrounding said shaft, first and second nipples, at least one damping bushing, an end-face seal, and an annular piston which is adapted to reciprocate in an annular chamber defined in the space between the cylindrical body and the tube and separates said annular chamber into two areas filled, respectively, with the dielectric fluid and the formation fluid arriving from the annulus, characterized in that the protector comprises two protective annular elements which are attached to the annular piston end-face, contacting the formation fluid, protrude beyond outline of the annular piston and are contiguous, respectively, to the cylindrical body interior surface and to the tube exterior surface, wherein the space between the protective annular elements and, respectively, the cylindrical body interior surface and the tube exterior surface is filled with a protective lubricant.

2. The protector as claimed in claim 1, characterized in that it comprises at least one additional annular piston positioned in the annular chamber, at the side of the annular piston end-face contacting the dielectric fluid, the additional annular piston is adapted to reciprocate in the annular chamber, wherein the space between the annular piston and the additional annular piston being filled with a separating medium.

3. The protector as Claimed in claim 2, characterized in that as the separating medium used is either a dielectric fluid having permittivity of 4-90 kW/cm, or a gas selected from the group consisting of air, an inert gas, hydrocarbon gas, a mixture of a dielectric fluid with a gas, or a protective lubricant.

4. The protector as claimed in claims 2 or 3, characterized in that the annular piston and/or additional annular piston is provided with at least one seal at the place where the piston contacts the cylindrical body interior surface, and at least one seal at the place where it contacts the tube exterior surface.

5. The protector as claimed in claims 2 or 3, characterized in that the annular piston and/or additional annular piston is provided with a supporting centering ring.

6. The protector as claimed in claims 2 or 3, characterized in that the space between the annular piston exterior surface and the cylindrical body interior surface, as well as the space between the additional annular piston exterior surface and the cylindrical body interior surface are filled with a protective lubricant.

7. The protector as claimed in claims 2 or 3, characterized in that the annular piston and/or additional annular piston have the barrel-shaped exterior surface.

8. The protector as claimed in claims 1 or 2, characterized in that the protective annular elements are implemented in the form of deformable tubes.

9. The protector as claimed in claims 1 or 2, characterized in that the protective annular elements are implemented as the corrugated elements.

10. The protector as claimed in claims 2 or 3, characterized in that the protective annular elements are implemented in the form of rigid tubes.

11. The protector as claimed in claim 9, characterized in that it comprises spring-loaded elements positioned inside the protective annular element contiguous to the cylindrical body interior surface, and outside the protective annular element contiguous to the tube exterior surface, the spring-loaded elements mechanically contacting said protective annular elements and urging said protective annular elements, respectively, towards the cylindrical body interior surface and towards the tube exterior surface.

12. The protector as claimed in claim 10, characterized in that the protective annular elements on their surfaces contiguous, respectively, to the cylindrical body interior surface and to the tube exterior surface, have recesses that accommodate the protective lubricant.

13. The protector as claimed in claims 10 and 12, characterized in that it comprises seals positioned outside the protective annular element contiguous to the cylindrical body interior surface, and inside the protective annular element contiguous to the tube exterior surface.

14. The protector as claimed in claims 1 or 2, characterized in that the second nipple has a passageway that connects the annular chamber's area, filled with the formation fluid, to the annulus, said passageway being provided with a filter therein.

15. The protector as claimed in claim 2, characterized in that the annular piston is provided with at least one port for charging the separating medium, in which port a locking device is positioned.

16. The protector as claimed in claims 1 or 2, characterized in that it comprises a pumping device positioned on the shaft between the annular chamber's area filled with the dielectric fluid and the end-face seal.

17. A hydroprotection compensator of a borehole pump electric motor, comprising a cylindrical body and a base secured on said cylindrical body, which base has a passageway for establishing the fluid communication of the cylindrical body interior cavity with the annulus, characterized in that it comprises a piston positioned inside the cylindrical body and adapted to reciprocate and separating the space within the cylindrical body into two cavities, which cavities are respectively filled with the dielectric fluid and the formation fluid arriving from the annulus, and a protective annular element which is attached to the piston end-face contacting the formation fluid, protrudes beyond outline of the piston and contiguous to the cylindrical body interior surface, wherein the space between the protective annular element and the cylindrical body interior surface being filled with a protective lubricant.

18. The compensator as claimed in claim 17, characterized in that it comprises at least one additional piston positioned inside the cylindrical body, at the piston side contacting the dielectric fluid, wherein the space between the piston and the additional piston being filled with a separating medium.

19. The compensator as claimed in claim 18, characterized in that as said separating medium used are either a dielectric fluid having permittivity of 4-90 kW/cm, or a gas selected from the group of air, an inert gas, hydrocarbon gas, a mixture of a dielectric fluid with a gas, or a protective lubricant.

20. The compensator as claimed in claims 18 or 19, characterized in that the piston and/or additional piston is provided with at least one seal at the place where said piston contacts the cylindrical body interior surface.

21. The compensator as claimed in claims 18 or 19, characterized in that the piston and/or additional piston is provided with a support centering ring.

22. The claimed in claims 18 or 19, characterized in that the space between the piston exterior surface and the cylindrical body interior surface, as well as the space between the additional piston exterior surface and the cylindrical body interior surface are filled with a protective lubricant.

23. The compensator as claimed in claims 18 or 19, characterized in that the piston and/or the additional piston has the barrel-shaped exterior surface.

24. The compensator as claimed in claims 17 or 18, characterized in that the protective annular element is implemented in the form of a deformable tube.

25. The compensator as claimed in claims 17 or 18, characterized in that the protective annular element is implemented as the corrugated element.

26. The compensator as claimed in claims 17 or 18, characterized in that the protective annular element is implemented in the form of a rigid tube.

27. The as claimed in claim 25, characterized in that it comprises at one spring-loaded element positioned inside the protective annular element, contiguous to the cylindrical body interior surface, the spring-loaded element mechanically contacts said protective element and urges the protective annular element towards the cylindrical body interior surface.

28. The protector as claimed in claim 26, characterized in that the protective annular element surface, contiguous respectively to the cylindrical body interior surface, has recesses to accommodate a protective lubricant.

29. The protector as claimed in claims 26 or 28, characterized in that it comprises a seal is positioned outside the protective annular element that is contiguous to the cylindrical body interior surface.

30. The compensator as claimed in claims 17 or 18, characterized in that it comprises a filter positioned in the base passageway which communicates the cylindrical body inner cavity communicates with the annulus.

31. The compensator as claimed in claim 18, characterized in that the piston is provided with at least one port for charging the separating medium, said port having a locking device.

32. A moveable mechanical module that separates, in a hydroprotection protector of borehole pump electric motor, the dielectric fluid and the formation fluid arriving from the annulus, and comprises an annular piston, characterized in that it comprises two protective annular elements attached to one of the annular piston's end-faces and protruding beyond outline of the piston, wherein first of said annular elements has the inner diameter approximately equal to the inner diameter of the annular piston, and the second of said annular elements has the outer diameter approximately equal to the outer diameter of the annular piston.

33. The module as claimed in claim 32, characterized in that the protective annular elements are implemented in the form of deformable tubes.

34. The module as claimed in claim 32, characterized in that the protective annular elements are implemented as the corrugated elements.

35. The module as claimed in claim 32, characterized in that the protective annular elements are implemented in the form of rigid tubes.

36. The module as claimed in claim 34, characterized in that it comprises at least one spring-loaded element positioned inside the protective annular element of the greater diameter and mechanically contacting said protective element, and at least one spring-loaded element positioned outside the protective annular element of the smaller diameter and mechanically contacting said protective element.

37. The module as claimed in claim 35, characterized in that outside the protective annular element of the greater diameter, and inside the protective annular element of the smaller diameter implemented are recesses that accommodate a lubricant.

38. The module as claimed in claim 32, characterized in that the annular piston has the barrel-shaped exterior surface.

39. The module as claimed in claim 32, characterized in that the annular piston is made of a corrosion-resistant metal, or a chemically-resistant and heat-resistant polymer material.

40. A moveable mechanical module that separates, in a hydroprotection compensator of a borehole pump electric motor, the dielectric fluid and the formation fluid arriving from the annulus, and comprises a piston, characterized in that it comprises a protective annular element which is attached to one of the end-faces of the piston, protrudes beyond outline of the piston and has the outer diameter being approximately equal to the piston's outer diameter.

41. The module claimed in claim 40, characterized in that the protective annular element is implemented in the form of a deformable tube.

42. The module as claimed in claim 40, characterized in that the protective annular element is implemented as the corrugated element.

43. The model as claimed in claim 40, characterized in that the protective annular element is implemented in the form of a rigid tube.

44. The module as claimed in claim 42, characterized in that it comprises at least one spring-loaded element positioned inside the protective annular element and mechanically contacting said annular element.

45. The module as claimed in claim 43, characterized in that outside the protective annular element implemented are recesses that accommodate a lubricant.

46. The module as claimed in claim 40, characterized in that the piston has the barrel-shaped exterior surface.

47. The module as claimed in claim 40, characterized in that the piston is made of a corrosion-resistant metal, or a chemically-resistant or heat-resistant polymer material.
